(19) United States
(12) Patent Application Publication
(10) Pub. No.: US 2002/0032771 A1
(43) Pub. Date: Mar. 14, 2002

(54) Event-based advertisements

(76) Inventor: Trond Gledje, Stockholm (SE)

Correspondence Address: Ronald L. Grudziecki, BURNS, DOANE, SWECKER & MATHIS, L.L.P., P.O. Box 1404, Alexandria, VA, 22313-1404, US

(21) Appl. No.: 09/907,899

(22) Filed: Jul. 19, 2001

Related U.S. Application Data
(60) Provisional application No. 60/219,442, filed on Jul. 20, 2000.

(51) Int. Cl. G06F 15/16

(52) U.S. Cl. 709/224; 709/218; 709/219

(57) ABSTRACT

A service provider solicits content providers to provide advertisements. Each content provider which desires to provide an advertisement will tag the advertisement with various attributes. These attributes comprises information type, zone/area related information, information attributes, information validity, information preferentials and language keys. The service provider then obtains the tagged advertisement information and stores the information in an advertisement database. The service provider then monitors, with the assistance of information provided by the mobile network, the activity of the mobile stations associated with subscribers to determine whether a mobile station has entered a zone/area which matches a zone/area in the advertisement database. If a mobile station has entered such an area, the mobile station has the service activated, and a demographic of a subscriber associated with the mobile station matches criteria specified by the advertiser, the service provider will provide the advertisement to the mobile station.

The present application claims priority under 35 U.S.C. §119(e) to U.S. Provisional Application No. 60/219,442 filed Jul. 20, 2000, the entire disclosure of which is herein expressly incorporated by reference.

### BACKGROUND

The present invention relates to advertisements, and more particularly, to methods and systems for providing event-based advertisements.

Advertising, in general, is intended to convey information related a product or service. Known media for advertising include television and radio commercials, billboards, telemarketing, direct mail solicitation and web-page based advertisements. To maximize the advertisers return on the expense of the advertisement it is advantageous to direct the advertisement to a specific demographic who is most likely to purchase the product or service being advertised. For example, the demographic which watches a particular television show or listens to a particular radio program is typically evaluated to determine if the same demographic would be interested in purchasing the product or service which is being advertised. Another example of targeting a demographic with an advertisement is to place billboards for restaurants along a highway several miles prior to the exit for the restaurant. The advertiser, the restaurant in this example, assumes that people driving along the highway may be interested in eating at some point during their journey. By placing the billboard prior to the exit to the restaurant, the restaurant is targeting people who are likely to have an interest in the service provided by the restaurant.

These conventional forms of advertising are by their nature a type of broadcast which, while providing products or services associated with their target audience, may not necessarily provide a product or service for which a particular end user is interested. For example, professional sporting events have a large demographic of males. Accordingly, during these professional sporting events advertisements are aired which are directed specifically to the male demographic. However, there are also a large number of females who watch or listen to professional sporting events who may not necessarily be interested in products or services that the male demographic is interested. However, due to the broadcast nature of television and radio, the same advertisement is presented to both males and females.

The recent proliferation of mobile stations such as cellular phones, personal digital assistants, and portable computers equipped with wireless modems, provides new media for advertisements. Due to the manner in which the mobile stations communicate with a mobile communication network, these mobile stations are separately addressable. Being separately addressable allows advertisements to be more accurately targeted to a particular demographic through unicast messaging to the address associated with the mobile station.

In addition to the broadcast versus unicast difference between conventional media for advertising and advertising on mobile stations, there are other features associated with mobile communication which are not encountered in conventional advertising media. For example, the channel through which the advertising is provided to an end user device and the capabilities of the end user device are known in conventional media. An advertisement which is to be aired on television is designed based upon the fact that all television channels, e.g., over the air, over cable or over satellite, provide a fixed bandwidth through which the advertisement can travel. Further, all televisions typically have the same display capabilities. However, not all mobile stations have the same amount of bandwidth between the mobile station and the mobile communication network, e.g., some mobile telephones may be limited to receiving short supplementary service (SMS) messages which are pure text, whereas other mobile stations which are designed to access third generation mobile communication networks can receive information in a similar manner to that of a computer at speed up to 384 kbps. Further, not all mobile stations have the same ability to display an advertisement, e.g., some mobile telephones have a two or four line display while a PDA or mobile computer can have many more lines for displaying information. Therefore, the assumptions made when designing advertisements for conventional media cannot be relied upon when designing advertisements for mobile stations.

Accordingly, it would be desirable to provide advertisements which account for the various capabilities of mobile stations. It would also be desirable to provide advertisements which account for the amount of bandwidth available to the mobile station. Further, it would be desirable to provide such a system which can be integrated into existing mobile communication networks.

### SUMMARY OF THE INVENTION

The present invention provides methods and systems for providing eventbased advertisements to mobile subscribers.

In accordance with one embodiment of the present invention, a service provider solicits subscribers with mobile stations to receive advertisements. The service provider also solicits content providers to provide advertisements. Each content provider which desires to provide an advertisement will tag the advertisement with various attributes. These attributes can comprise information type, zone/area related information, information attributes, information validity, information preferentials and language keys. The service provider then obtains the tagged advertisement information and stores the information in an advertisement database. The service provider then monitors, with the assistance of information provided by the mobile network, the activity of the mobile stations associated with subscribers to determine whether a mobile station has entered a zone/area which matches a zone/area in the advertisement database. If a mobile station has entered such an area, and if the mobile station has the service activated, the service provider will provide the advertisement to the mobile station.

In accordance with one aspect of the present invention, the service provider maintains a subscriber database. The subscriber database can comprise information regarding the capability of the mobile station, the type of connection the mobile station has with the mobile network, the information type, the information profile, the language keys and whether the advertisement service has been activated by the mobile station.

The use of the service provider in accordance with the present invention reduces the burden on a content provider to advertise with mobile stations. Further, the present invention can account for various capabilities of mobile stations including the ability to reproduce different media and the type of connection the mobile station has with the mobile network. Additionally, the present invention is easily integrated into existing mobile communication network. The present invention can also provide mobile stations with information that may be of interest to a subscriber associated with a mobile station based upon time of day, day of the week, demographics associated with the subscriber and/or the location of the mobile station.

### BRIEF DESCRIPTION OF THE DRAWINGS

FIG. 1 illustrates an exemplary communications network for providing advertisements to mobile stations in accordance with the present invention;

FIG. 2A and 2B respectively illustrate an entry in an advertisement database and in a subscriber database in accordance with exemplary embodiments of the present invention;

FIG. 3 illustrates a method for obtaining advertisements in accordance with exemplary embodiments of the present invention;

FIG. 4 illustrates a method for obtaining subscribers to receive advertisements in accordance with exemplary embodiments of the present invention; and

FIG. 5 illustrates an exemplary method for providing advertisements to subscribers in accordance with the present invention.

### DETAILED DESCRIPTION

In the following description, for purposes of explanation and not limitation, specific details are set forth in order to provide a thorough understanding of the present invention. However, it will be apparent to one skilled in the art that the present invention may be practiced in other embodiments that depart from these specific details. In other instances, detailed descriptions of well-known methods, devices, and circuits are omitted so as not to obscure the description of the present invention.

In the following, the term advertisement is used in a general sense and is not intended to limit the present invention to what is conventionally thought of as advertisements. Instead the term advertisement is used to represent providing of information to an end user. For example, whereas in conventional advertising it is immediately evident that what is being provided is an advertisement, the present invention can provide information which to an end user may not appear to be an advertisement and instead is viewed as valuable information. For example, the present invention can be used to provide information to a mobile station regarding parking garages with available parking spaces in a particular area. The end user views this information as useful information, whereas the order in which the information is presented or whether the information is presented at all may depend upon whether a particular parking garage is a paying advertiser of the operator who provides this information.

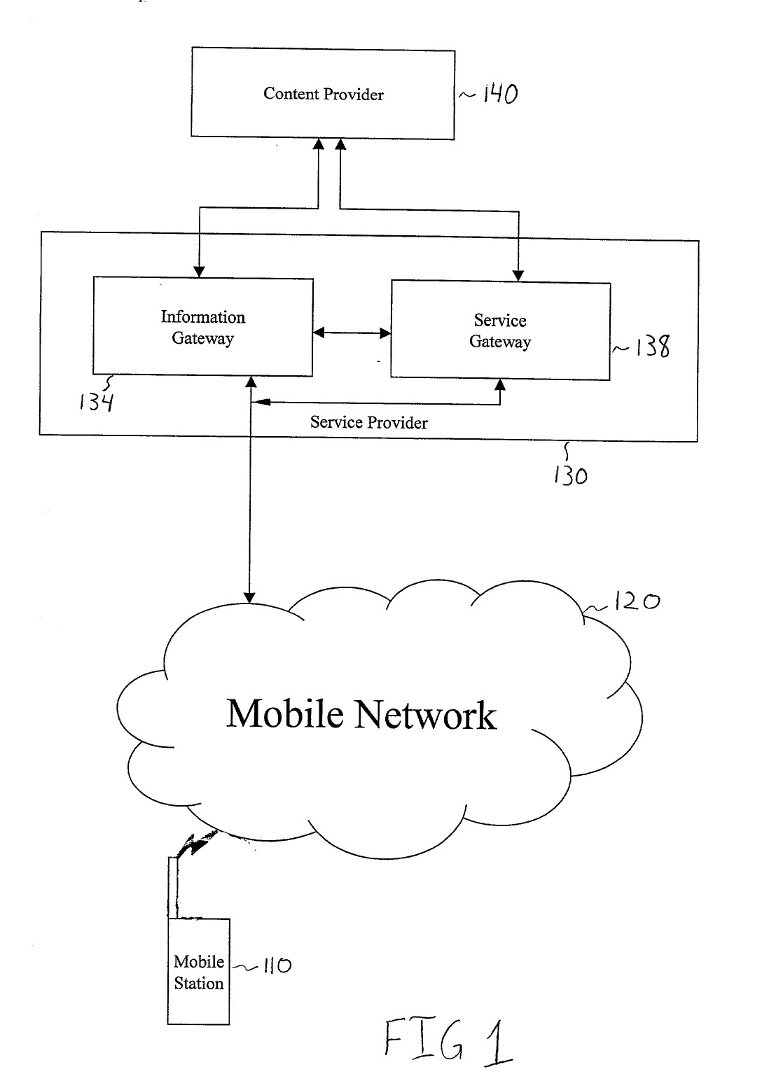

FIG. 1 illustrates an exemplary communications network for providing advertisements to mobile stations in accordance with the present invention. The communications network includes a mobile station 110, a mobile network 120, a service provider 130 and a content provider 140. The illustration in FIG. 1 of a single content provider and a single mobile station is for ease of explanation and is not intended to limit the present invention in any way. It will be recognized that the present invention can be implemented with more than one content provider and more than one mobile station. Further, although FIG. 1 illustrates the service provider interacting with a single mobile network, the service provider can also interact with more than one mobile network.

The service provider includes an information gateway 134 and a service gateway 138. In accordance with the present invention, service provider 130 acts as an intermediary between content provider 140 and mobile station 110. A content provider 140, which can be an advertiser or a provider of some type of information, provides the advertisement to service provider 130. In accordance with one exemplary embodiment of the present invention, the advertisement can be coded in accordance with eXtensible Markup Language (XML). Service provider 130 then provides the advertisement to a particular demographic of mobile stations based upon the particular demographic selected by content provider 140. The advertisement may be provided in an electronic mail, an SMS message or an unstructured supplementary service data (USSD) message.

As mobile stations which have subscriptions with service provider 130 set up a call or enter a new zone (as defined by the service provider), the service provider 130 examines the criteria specified by the content provider 140 to determine whether the information provided by the subscriber matches the criteria. If the criteria matches, the service provider 130 sends the advertisement to the mobile station associated with the subscriber. The setting up of a call or the position of a mobile station within the mobile network are mobile network related events which can be provided by base station controllers/mobile switching centers (BSC/MSC) which are modified to provide this information to the service provider 130.

In accordance with exemplary embodiments of the present invention, service provider 130 is an Internet service provider (ISP), e.g., a mobile ISP, which provides Internet access. A mobile ISP includes the necessary equipment for interacting with a mobile network to provide Internet access to mobile stations regardless of the current location of the mobile stations. Accordingly, a mobile ISP will include the necessary interfaces for communicating with various components of the mobile network including home location registers, visitor location registers and gateway location registers. Moreover, since users of mobile stations which access the Internet through a mobile ISP are already subscribers of the mobile ISP, the mobile ISP has a built in subscriber base to provide the advertisements.

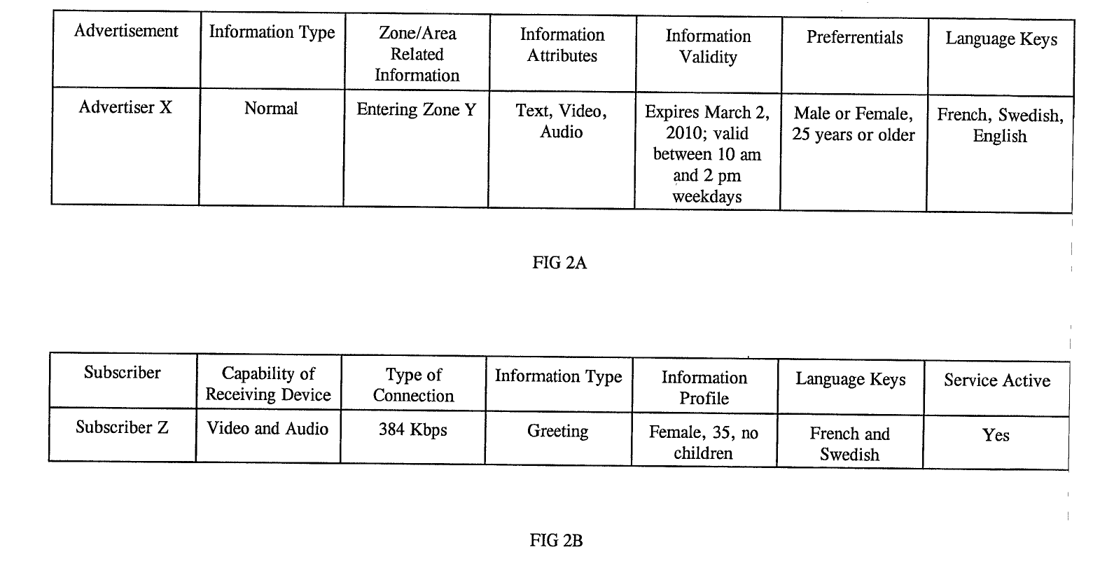

Information gateway 134 stores all of the relevant information for both advertisers and mobile stations which subscribe to the advertisement service. Accordingly, content providers 140 provide their advertisements and associated information to information gateway 134. FIG. 2A illustrates an entry in an advertiser database in accordance with exemplary embodiments of the present invention. Each advertisement which is provided to information gateway 134 is tagged by the advertiser with various attributes. As illustrated in FIG. 2A the attributes associated with each advertisement can include the information type, zone/area related information, information attributes, information validity, preferentials and language keys. Information type identifies whether the information is a normal advertisement or a greeting advertisement. Zone/area related information identifies a particular area associated with the advertisement. A zone/area can be of any size or shape and can be tailored to satisfy the needs of the content provider. For example, an advertisement may only be displayed to mobile stations entering a particular cell or entering another type of predetermined geographic region. Additionally, an advertisement may only be displayed to mobile stations originating a call in a cell or within another type of geographic region.

Information attributes identifies the form for which a particular advertisement is to be displayed. For example, some advertisements may be designed such that any one of the following may be displayed to a subscriber associated with a mobile station: text, graphics, video, and/or audio. Information validity indicates a time period during which an advertisement may be displayed. The information validity may be as simple as an expiration date or may include certain times of the day for which an advertisement may be displayed. Preferentials indicates various demographic information associated with the subscriber to which the advertisement is directed. The demographic information is used as a criteria for determining whether an advertisement should be sent to a particular mobile station. Language keys identifies the particular languages in which the advertisement may be displayed. For example, an advertiser may provide an advertisement in English, French and Swedish.

FIG. 2B illustrates an entry in a subscriber database in accordance with exemplary embodiments of the present invention. The subscriber database includes fields for the capability of the receiving device, the type of connection of the receiving device, the information type, an information profile, language keys and service active. The capability of receiving device field identifies whether the receiving device is capable of providing motion video, still video, audio and/or text. The type of connection field identifies the type and the amount of bandwidth of a connection between the mobile station and the mobile network. This field can either be a static field which indicates the maximum bandwidth achievable by the mobile station or can be dynamic where the mobile network updates the database as to the bandwidth currently available to the mobile station. The information type field indicates whether the subscriber wishes to receive normal advertisements and/or greeting type advertisements. The information profile field provides demographic information associated with the subscriber associated with the mobile station. This information can either be general information provided when the subscriber originally subscribed with the mobile ISP such as age and gender, or can be more detailed information such as the number of people in the subscriber's household, the average annual income for the household, or even the type of food preferred by the subscriber. The language key field identifies the languages which the subscriber can understand. This field can include all languages understood by the subscriber or can include an list in order of language preference. The service active field indicates whether the subscriber associated with the mobile station has activated the advertisement service or whether the subscriber wishes not to receive advertisements.

The subscribers can inform, update and enable the advertisement service through a web-interface or through a voice communication via a dial up interface that the subscriber wishes to be notified of specific information in selected service areas. Through the web-interface the subscriber can, by a mouse click operation, update the information stored in the subscriber database.

Returning now to FIG. 1, the service gateway 138 has two main functions. The first function is to allow subscriber control of the advertisements provided. The subscriber control is achieved by the subscriber providing information which is used to populate the fields of the subscriber database. The subscriber can provide this information either through a web page provided by the service provider, to a telephone operator of the service provider, or the subscriber can fill out a questionnaire which is mailed to the service provider who manually enters the subscriber information into the subscriber database.

The second function of the service gateway 138 is to control delivery of the advertisements to mobile stations. It should be recognized that although the service gateway 138 controls delivery of the advertisements, the actually delivery of the advertisements to the mobile network is performed by information gateway 134. Accordingly, the service gateway 138 collects information from the mobile network and uses the information contained in the advertisement database and the subscriber database to determine whether the mobile station has enabled the sending of information by the service provider (such an indication can be stored in and provided by an HLR), and whether a particular advertisement should be provided to a particular mobile station.

The information provided by the mobile network to the service gateway can include whether the mobile station is registered in the mobile network, i.e., whether the mobile station is turned on and monitoring a control channel of the mobile network, which cell of the mobile network the mobile station is located, the position of the mobile station in the mobile network and whether the mobile station is entering a particular cell or location. The mobile network can provide more detailed location information than just the particular cell a mobile station is located using techniques such as triangulation or mobile station equipped GPS positioning. In this instance, the mobile station will provide the position information to the service provider.

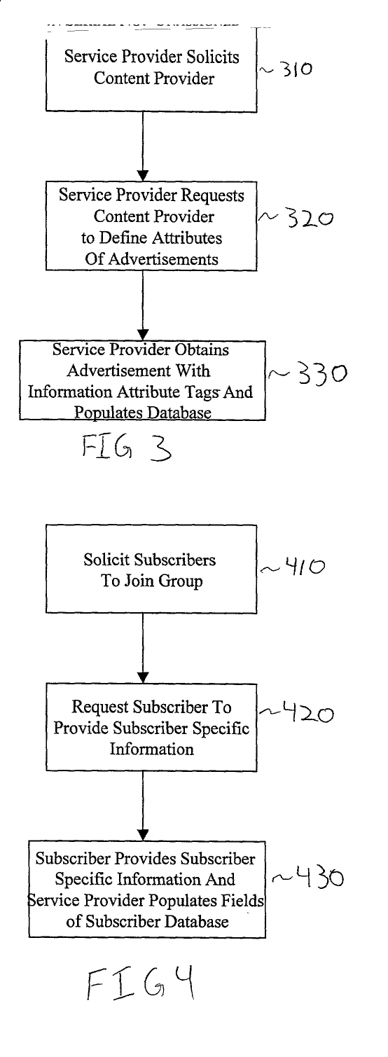

FIG. 3 illustrates an exemplary method for obtaining advertisements in accordance with the present invention. Initially, the service provider solicits content providers to provide advertisements (step 310). This solicitation can take any form including, but not limited to, direct mail solicitation, telemarketing, and in person solicitations. The service provider then requests that the content provider define attributes of the advertisements (step 320). The content provider defines the attributes of the advertisements by tagging the advertisements. The service provider then obtains the advertisement tagged with the particular attribute information and populates the advertisement database with the tagged information (step 330).

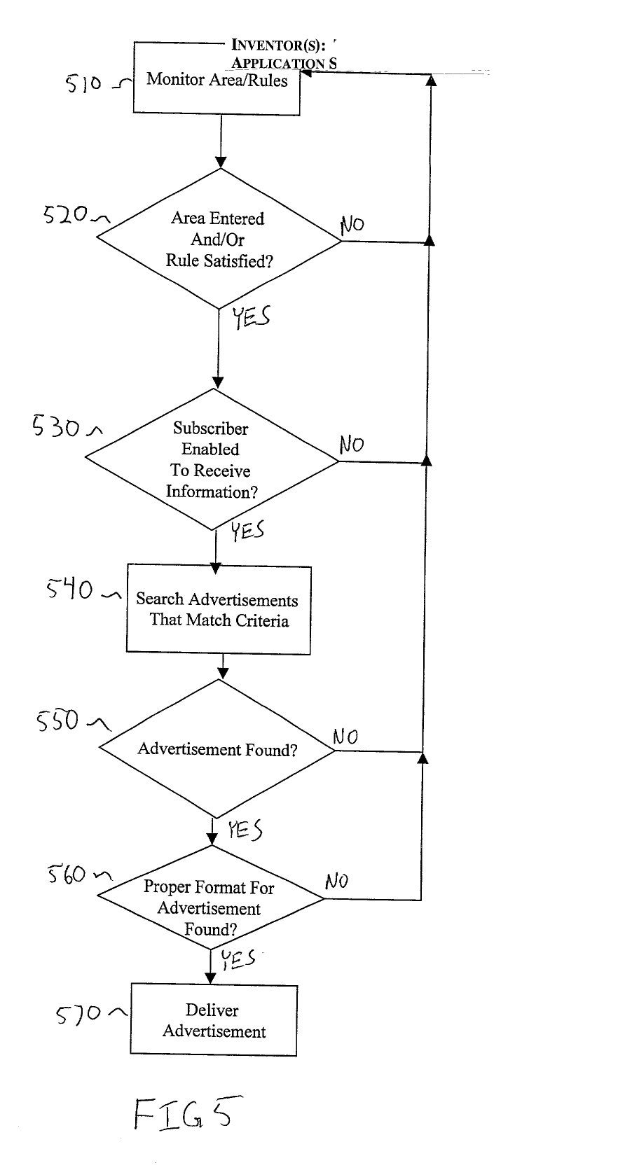

FIG. 4 illustrates a method for obtaining subscribers to receive advertisements in accordance with exemplary embodiments of the present invention. Initially, the service provider solicits subscribers to join the advertisement service (step 410). These subscribers can include subscribers of the mobile ISP. However, the service provider can also solicit subscribers associated with mobile stations which are not already subscribers of the mobile ISP. The form of the solicitation can include direct mail, electronic mail, telemarketing or any other form of solicitation. Upon a successful solicitation, the service provider requests that the subscriber provide subscriber specific information (step 420). The subscriber then provides the subscriber specific information and the service populates fields of the subscriber database using the subscriber specific information (step 430).

FIG. 5 illustrates an exemplary method for providing advertisements to subscribers in accordance with the present invention. Areas and rules associated with various advertisements are monitored by the service gateway to determine whether the area has been entered by a mobile station or whether the rule has been satisfied (step 510). In accordance with one embodiment of the present invention, the rule is whether a mobile station is originating a call. The service gateway performs the monitoring by accessing information in the advertiser and subscriber databases and comparing this information with information received from the mobile network.

Next it is determined whether an area has been entered and/or a rule has been satisfied (step 520). If an area has not been entered and/or a rule has not been satisfied (“No” path out of decision step 520) then the service gateway continues to monitor the area/rules (step 510). If, however, an area has been entered and/or a rule has been satisfied (“Yes” path out of decision step 520) then it is determined whether the subscriber who entered the area or who satisfied the rule has their mobile station enabled to received information (step 530). As discussed above, a mobile subscriber can enable and disable the receipt of advertisements from the service provider and an indication of such can be stored in, and provided by, the HLR associated with the mobile station.

If the subscriber has not enabled the mobile station to receive information (“No” path out of decision step 530) then the service gateway continues to monitor areas and rules (step 510). If, however, the subscriber has enabled the mobile station to receive information (“Yes” path out of decision step 530) then the service gateway searches for advertisements which match criteria associated with the subscriber associated with the mobile station (step 540). The criteria are based upon information in the advertiser and subscriber databases and can include: whether the information type specified by the content provider matches the information type specified by the subscriber; and whether the demographic information in the information profile matches preferrentials specified by the content provider.

Next it is determined whether an advertisement has been found which satisfies the criteria associated with the mobile station (step 550). If it is determined that there is not an advertisement which satisfies the criteria (“No” path out of decision step 550) then the service gateway continues to monitor area and rules (step 510). If it is determined that an advertisement has been found which satisfies the criteria (“Yes” path out of decision step 550) then the service gateway searches to determine whether the correct advertisement format for the particular mobile station is found in the advertiser database (step 560). The advertisement format includes: whether the attributes of the information can be reproduced by the mobile station (the capability of the receiving device); whether the type of connection of the mobile station can support the information attributes; and whether the advertisement is in a language which can be understood by the subscriber. If the advertisement stored in the advertisement database does not match a format which can be reproduced by the mobile station (“No” path out of decision step 560) then the service gateway continues to monitor the area and rules (step 510). If, however, the advertisement is stored in a format which can be reproduced by the mobile station (“Yes” path out of decision step 560) then the information gateway, under control of the service gateway, delivers the advertisement to the mobile station (step 570).

The accounting for each advertisement provided to a mobile station is handled by billing subsystem (not illustrated) of the service provider. This accounting can include payment to mobile stations for receiving advertisements, payment to mobile ISPs for providing position information of mobile stations and for carrying the advertisements over their network, and billing the advertisers for providing the advertisement service. Any type of payment model can be employed by the present invention, including, but not limited to, payment for each advertisement sent, payment of a fixed cost per month, or payment for each advertisement which results in a sale for the advertiser. In exchange for receiving the advertisements, subscribers may receive some type of compensation, for example, monetary compensation and/or free air time. Another type of compensation to subscribers could be providing subscribers with coupons in connection with the advertisements which can be used at the company associated with the advertisement.

The present invention has been described with reference to several exemplary embodiments. However, it will be readily apparent to those skilled in the art that it is possible to embody the invention in specific forms other than those of the exemplary embodiments described above. This may be done without departing from the spirit of the invention. These exemplary embodiments are merely illustrative and should not be considered restrictive in any way. The scope of the invention is given by the appended claims, rather than the preceding description, and all variations and equivalents which fall within the range of the claims are intended to be embraced therein.

What is claimed is:

1. A system for providing advertisements to mobile stations comprising:
a service provider, wherein the service provider includes an information gateway and a service gateway;
a content provider for providing an advertisement to the service provider; and
a mobile station,
wherein the service provider receives information associated with the mobile station from a mobile network, and
wherein the mobile station receives the advertisement if the mobile station satisfies a predetermined condition associated with the advertisement.

2. The system of claim 1, wherein the predetermined condition is setting up a call or entering a predetermined location.

3. The system of claim 1, wherein the service gateway receives information associated with the mobile station from the mobile network and wherein the information gateway provides the advertisement to the mobile station under the control of the service gateway.

4. The system of claim 1, wherein the content provider provides the advertisement to the service provider tagged with certain information.

5. The system of claim 4, wherein the tags are selected from the group consisting of:
information type;
zone/area related information;
information attributes;
information validity;
preferentials; and
language keys.

6. The system of claim 1, wherein the service provider is a mobile Internet service provider.

7. The system of claim 1, wherein the service provider stores information related to the mobile station.

8. The system of claim 7, wherein the information related to the mobile station is selected from the group consisting of:
capability of the mobile station;
type of connection associated with the mobile station;
information type;
information profile;
language keys; and
whether the mobile station has activated receipt of advertisements.

9. The system of claim 1, wherein the mobile station receives the advertisement only if subscriber specific information associated with the mobile station and the capabilities of the mobile station match criteria associated with the advertisement.

10. A method for providing advertisements to a mobile station in a mobile network comprising the steps of:
soliciting, by a service provider, content providers;
providing an advertisement, by a content provider, to the service provider, wherein the advertisement includes information associated with the advertisement;
soliciting, by the service provider, subscribers with mobile stations; and
sending the advertisement to the mobile station if the mobile station satisfies a predetermined condition associated with the advertisement.

11. The method of claim 10, wherein the predetermined condition is setting up a call or entering a predetermined location.

12. The method of claim 10, wherein the service provider includes a service gateway and an information gateway, the method further comprising the steps of:
receiving, by the service gateway, information associated with the mobile station from the mobile network; and
controlling, by the service gateway, the provision of the advertisement by the information gateway.

13. The method of claim 10, wherein the information associated with the advertisement is selected from the group consisting of:
information type;
zone/area related information;
information attributes;
information validity;
preferentials; and
language keys.

14. The method of claim 10, wherein the service provider is a mobile Internet service provider.

15. The method of claim 10, further comprising the step of:
storing, by the service provider, information related to the mobile station.

16. The method of claim 15, wherein the information related to the mobile station is selected from the group consisting of:
capability of the mobile station;
type of connection associated with the mobile station;
information type;
information profile;
language keys; and
whether the mobile station has activated receipt of advertisements.

17. The method of claim 10, further comprising the step of:
receiving, by the mobile station, the advertisement only if subscriber specific information associated with the mobile station and the capabilities of the mobile station match a criteria associated with the advertisement.
